(19) United States
(12) Patent Application Publication
(10) Pub. No.: US 2005/0185535 A1
(43) Pub. Date: Aug. 25, 2005

(54) Tilt compensating apparatus and method and optical recording and reproducing apparatus using the tilt compensating method

(76) Inventor: Toshiyuki Kawasaki, Kanagawa (JP)

Correspondence Address: DICKSTEIN SHAPIRO MORIN & OSHINSKY LLP, 2101 L Street, NW, Washington, DC, 20037, US

(21) Appl. No.: 11/062,574

(22) Filed: Feb. 23, 2005

(30) Foreign Application Priority Data
Feb. 23, 2004 (JP) 2004-046266

(51) Int. Cl. G11B 7/09

(52) U.S. Cl. 369/44.32; 369/53.19; 369/53.12

(57) ABSTRACT

A tilt compensation apparatus and method minimizes a coma aberration generated due to a tilt of an optical disc by canceling a tilt offset amount of a tilt sensor. An objective lens converges a light emitted by a light source mounted on an optical pickup and irradiating the light onto a recording surface of the optical disc. An objective lens tilt actuator controls tilt of the objective lens. An objective lens tilt sensor detects an amount of tilt of the objective lens. An optical disc tilt sensor detects an amount of tilt of the optical disc. An operator computes an amount of relative tilt between the objective lens and the optical disc in accordance with the amount of tilt detected by the objective lens tilt sensor and the amount of tilt detected by the optical disc tilt sensor. A memory part stores an amount of offset of tilt generated in each of the tilt sensors. An offset adjuster adjusts an amount of offset of tilt of the optical pickup in accordance with the amount of offset of tilt stored in the memory part.

### BACKGROUND OF THE INVENTION

1. Field of the Invention

The present invention relates to a tilt servo control technique of a recording and reproducing apparatus using an optical recording medium (optical disc) and, more particularly, to a tilt compensating apparatus and method using a tilt correcting means that corrects a tilt error and an optical recording and reproducing apparatus using such a tilt compensating method.

2. Description of the Related Art

In recent years, a low-cost and large-scale screen with fine resolution has become realized in a display apparatus such as a liquid-crystal display, a plasma display or a high-brightness and high-resolution large screen projector. In coming several years, it is expected that those high-resolution displays will become popular for home use, and contents of high-resolution video will become popular rapidly due to broadbandization of networks. Under such circumstances, like the rapid spread of package media of DVD, it is considered that needs for DVDs having contents of high-resolution vided will be increased in the future. Additionally, it is expected that there is a demand for a combination multi-drive compatible with both the optical disc such as a compact disc and the next generation large capacity DVD in optical disc drives for personal computer that occupy a large part of the optical disc drive market.

Under such a background, it is required to formulate a standard for the next generation large capacity DVD in consideration of the following merits.

1) The infrastructure of manufacturing disc media of the existing DVD can be shared so that a disc manufacturing cost is reduced, which meets the demand of the contents/media industry.

2) A compatibility of reproducing the existing DVD can be easily achieved.

3) It is possible to make a disc structure having no cartridge like the existing DVD. A thin drive can be easily realized, which is suitable for a notebook type personal computer and compatible with various optical discs.

4) A double layer disc is easily realized so as to make a large capacity disc due to a lamination structure of a 0.6 mm disc, which is the same as the existing DVD.

5) A capacity is equal to or more than 25 GB so that contents of high-resolution video can be recorded for 2 hours in one-side single layer media.

As a candidate for a large-capacity optical disc that replaces the existing DVD, a blue-ray disc (hereinafter, referred to as BD) was announced, which attains a one-side single layer capacity of 27 GB. Thereafter, an advanced optical disc (AOD) was announced as a competing standard of the BD. Both are candidates of the next generation large-capacity optical disc using a blue laser having a wavelength of 405 nm.

A brief description will be given of an outline of the BD. The BD is a video recorder standard of the next generation large-capacity optical disc, which uses a blue violet laser of a wavelength of 405 nm and video data of a maximum of 27 GB can be repeatedly recorded on or reproduced from a one-side single layer of a phase-change type optical recording medium having a diameter of 12 cm the same as a CD or a DVD. In the BD technique, a blue violet laser of a short wavelength is used and a numerical aperture (NA) of an objective lens, which is a key component to converge a laser light, is set to 0.85 so as to reduce a spot diameter of an optical beam.

A description will be given of an outline of the AOD. It is a feature of the AOD, which is another standard competitive with the BD, that the AOD has a technical compatibility with the existing DVD standard. A numerical aperture of an objective lens, which converges a laser light, is set to 0.65 and a distance (depth) from a surface of an optical disc to a recording layer is set to 0.6 mm so as to be the same as the existing DVD.

The AOD has advocated a reproduction only disc oriented for package media such as high-resolution video media and a rewritable type disc standard for recording/reproducing. The AOD adopts the same structure as the existing DVD in which two discs having a diameter of 120 mm and a thickness of 0.6 mm. Thus, the AOD can share an optical system of an optical pickup and a manufacturing apparatus of an optical disc with the existing DVD, thereby reducing a cost.

Although the storage capacity of DVD of one disc is about 5 to 10 GB, the storage capacity of a reproduction only AOD is 15 GB with a single-sided single-layer and 30 GB with a single-sided dual-layer. The storage capacity of a rewritable type AOD is 20 GB with a single-sided single-layer, and standardization of an optical disc of 40 GB with a single-sided dual-layer is considered. A file format is UDF (Universal Disc Format). A data transfer rate is 36 Mbps. A numerical aperture of an objective lens is 0.65. A reproduction signal process is PRML (Partial Response Maximum Likelihood). A modulation method is ⅔ modulation. According to a proposed standard, a blue laser having a short wavelength is used for a laser light for signal reading and writing, and a signal processing technique corresponding to a high-density optical disc and a phase-change type media suitable for high densification are used.

Comparing the BD with AOD, a numerical aperture (NA) of the BD is 0.85 and a thickness of a substrate is 0.1 mm so as to forcibly converge a laser light at a position close to a surface of an optical disc to form an extremely small spot, which produces a difference of 7 GB in the storage capacity. The BD has less compatibility with the existing DVD in its optical system and disc structure. In a case of the mainstream dual-layer optical disc, an optical disc of the DVD and the AOD can be made by lamination, but an optical disc according to the BD must be formed by stacking from one side. Moreover, the AOD is based on cartridgeless type as is the same as the existing DVD, but, the BD is based on a cartridge type since the recording layer is close to a surface, which provides a low contamination resistance.

Contents providers such as media makers and movie companies are concerned about cost increase in an optical disc accommodated in a cartridge. Considering introduction into PC environment, an optical disc accommodated in a cartridge is disadvantageous in mounting to a notebook type PC. It should be noted that the present BD is a standard for a recordable disc, and a ROM standard is now under consideration. In the ROM standard, the optical disc may be of a cartridgeless type.

On the other hand, the AOD has a capacity of 20 GB with a single-sided single layer recording disc, which is less than the BD by 7 GB. This means that the BD cannot store high-resolution contents such as a movie created in the future, and the difference in recording capacity may be a fatal flaw for the next generation large capacity disc.

Therefore, there are merits and demerits in both the standards of the next generation large-capacity disc, and each of the standards is not sufficient for the next generation large-capacity disc. Thus, it is necessary to create a new standard in which a problem related to the compatibility of the BD with CD and DVD and a problem with respect to a capacity of the AOD are eliminated.

Moreover, there is a relationship between the numerical aperture NA and the spot diameter omega0, which indicates that a wavelength λ should be decreased or the numerical aperture NA should be increased so as to decrease the spot diameter ω0. According to the BD, the storage capacity of 27 GB is achieved with a single-sided single layer by decreasing a spot diameter by decreasing the wavelength of the light source to 405 nm and increasing NA to 0.85.

Considering compatibility with CD and DVD and use on a PC, especially, a notebook-type PC, it is preferable that a numerical aperture NA of an objective lens is set to 0.65 and a thickness of a substrate is set to 0.6 mm. However, it is difficult to achieve high-density recording since a spot diameter is increased as the numerical aperture is decreased. According to the AOD, only a storage capacity of 20 GB is achieved due to binary recording although inter-code interference is permitted by using PRML so as to aim the same effect as the case where a spot diameter is decreased.

It is needed to compensate for a decrease in the storage capacity according to a write method such as multi-value recording or signal processing. When the multi-value recording is adopted, unlike the conventional binary recording, inter-code interference of adjacent level values is increased if an RF signal level fluctuates, which increases an error rate. That is, a margin to an RF signal level fluctuation decreases relative to that of the binary recording.

In an optical disc apparatus, recoded information is reproduced by scanning minute recording marks on an optical disc by an optical beam converged by an objective lens and detecting a light reflected by the recording marks. At this time, the recording surface of the optical disc may incline with respect to the light from an optical pickup for various reasons such as a warp and side0runout of the optical disc and a inclination when assembling a spindle. In such a case, since the light beam for reproducing the information recorded on the optical disc is not perpendicularly incident on the information recording surface, a coma aberration is generated in the optical beam spot on the information recording surface. The coma aberration does not only generate asymmetry in the spot configuration but also decreases an amount of light in the main spot and changes an RF signal level. Thus, an error rate is increased in multi-value recording, which results in achieving accurate reading of recorded information.

Especially if the thickness of the substrate is set to 0.6 mm to be larger relative to the wavelength, like the AOD, so as to acquire compatibility with DVD, an amount of a coma aberration due to a tilt of the optical disc is large, which results in difficulty in maintaining a sufficient margin with respect to a tilt of an optical disc.

Therefore, in the next generation optical disc, which attains a large-capacity and a high-density, a function to compensate for a tilt of an optical disc is an inevitable technique.

Japanese Laid-Open Patent Application No. 2002-260264 (patent document 1) discloses a principle of tilt compensation using a four-axis actuator (hereinafter, referred to as ACT). As shown in FIG. 1, an objective lens (hereinafter, referred to as OL) is usually positioned in parallel to an optical disc 5, and is supported by wires of the four-axis ACT 7. If a focus is made on the recording surface of the optical disc 5 in the state shown in FIG. 1, a spot configuration is observed as a circular shape as indicated on the optical disc 5 of FIG. 9. However, if an optical disc inclines and a tilt is generated as shown in FIG. 2, the spot configuration becomes an elliptic shape as indicated on the optical disc 5 of FIG. 2 and a coma aberration is generated further, and, thus, an irradiation light cannot be converged on the surface of the optical disc 5.

Thus, as shown in FIG. 3, the OL 2 is tilted using the four-axis ACT 7 so as to position the OL 2 to be parallel to the optical disc 5, and, thereby the spot configuration becomes circular shape and the tilt of the optical disc 5 can be compensated for. The four-axis ACT 7 can perform a control of a radial tilt and a tangential tilt in addition to the focus and track control which a conventional ACT performs.

A description will be given in more detail, with reference to FIG. 4, of the tilt compensating system. FIG. 12 is an illustration of an outline structure of the conventional tilt compensating apparatus. In the system shown in FIG. 12, an OL tilt sensor 10 is located under the OL 2 so as to detect a tilt amount of the OL 2. The OL tilt sensor 10 detects a tilt amount of the OL 2 and converts it into an electric signal. On the other hand, an optical disc tilt sensor 13 is provided on a side of the optical disc 5 so as to detect a tilt of the optical disc 5. The optical disc tilt sensor 13 detects a light reflected by the optical disc 5 by a two-divided PD (photo-detector) by a change in a light distribution of the light detected by the two-divided PD. A difference between output signals of the two tilt sensors, and supplies a signal corresponding to the difference to an OLACT (objective lens) driver 14. The OLACT driver 14 drives an OLACT 8 in accordance with the difference signal of the tilt sensor.

A description will now be given of an operation of the tilt compensation system. In FIG. 4, a first switch (SW) 11 is connected to a servo pull-in circuit 15 and a second switch (SW) 12 is turned off when the optical disc 5 is loaded. A servo pull-in operation is performed by the servo pull-in circuit 15, and the first switch (SW) 11 is connected to a compensator 9 so as to form a closed) loop, when the tilt amount of the OL 2 is “0”, to drive a OL tilt servo. Then, the second switch 12 is closed to cause the OL tilt amount to follow an optical disc tilt signal from the optical disc tilt sensor 13.

Additionally, Japanese Laid-Open Patent Application No. 2003-016677 (patent document 2) discloses a tilt control similar to the above-mentioned OL tilt control using a four-axis ACT, wherein the tilt control is performed so that an axis of a light beam is caused to be perpendicular to a surface of an optical disc so as to follow a warp of the optical disc.

Further, Japanese Laid-Open Patent Application No. 2000-187866 (patent document 3) discloses a tilt servo drive method in which a lens tilt servo is first performed in accordance with an output of t lens tilt sensor, and, thereafter, a relative tilt servo is performed in accordance with a lens/disc relative tile sensor. Additionally, Japanese Laid-Open Patent Application No. 2000-276756 (patent document 4) discloses a drive method of a tilt servo in which an objective lens support member is moved to about center in a focus direction by a focus drive means of the lens actuator before pull-in of a tilt servo.

Furthermore, Japanese Laid-Open Patent Application No. 11-144280 (patent document 5) discloses an optical disc apparatus in which a tilt sensor is provided to an OL holder of an ACT so as to detect a relative tilt between the OL and the optical disc, wherein an OL tilt drive amount is calculated based on the relative tilt value of the OL and the optical disc so as to drive the ACT by the OL tilt drive amount to perform a tilt compensation of the optical disc. However, an optical aberration is dependent on a lens configuration of the OL, and there are many cases in which a lens tilt angle at which an aberration is minimum is not equal to a tilt angle of an optical disc. That is, there is a case where an aberration cannot be reduced even if the optical axes of an optical disc and an objective lens are maintained to be perpendicular to each other. Thus, the above-mentioned optical disc apparatus has servo signal computing means for computing a servo signal at which a tilt angle of an OL holder relative to an optical disc is n times (n is a number excluding 1).

The above-mentioned tilt compensation system using the four-axis ACT disclosed in the patent document 1 or 2 is a compensation method in which a tilt amount of an optical axis is detected so as to tilt an objective lens in accordance with the detected tile amount. As shown in FIG. 4, the sensor in the closed loop of the OL tilt servo is only the OL tilt sensor 10, and the control loop of the optical disc tilt sensor 13 side is not a closed loop but an open loop. Therefore, if there is an offset between the optical disc tilt sensor 13 and the OL tilt sensor 10, all of the relative offsets correspond to control errors. If a maximum value of the tilt amount of the optical disc 5, which must be corrected, is set to 0.1 degree and a closed loop gain of the OL tilt servo is set to 40 dB, a control error generated in the servo system is 0.8×10⁻⁵ rad. Thus, although the control error generated in the servo system is small enough, the offset generated by the tilt sensor is much larger, and, therefore, it is an important issue for the radial and tangential tilt compensation system to decrease the offset generated by the tilt sensor.

Moreover, although the patent documents 3 and 4 describe pull-in procedure of the pull-in method of a tilt servo, such a procedure cannot provide means for solving the problem of the offset generated by a tilt sensor. Each tilt sensor always has a residual offset even after adjusted at a time of assembling, and a value of such a residual offset is considerably large with respect to a tilt mount to be controlled.

Furthermore, in the apparatus disclosed in the patent document 5, in the case where the OL tilt is controlled using a servo signal at which the tilt angle of the OL holder with respect to the optical disc is n times (n is a predetermined number excluding 1), a large control error may be generated in the signal to be multiplied by n, especially, when the tilt amount is small, if “0” point of the tilt amount is unknown. That is, if the optical disc tilt amount is compensated by a tilt control of the OL in a state where the offset amount of the relative tilt sensor between the OL and the optical disc and an offset amount of the optical disc tilt sensor are not accurately grasped or are not adjusted to “0”, the ACT may be driven, for example, with a signal which is n times the offset amount in the output value of the tilt sensor despite that the true value of the optical disc tilt amount is “0”. In such a case, although the tilt amount of the ACT is optimum when it is set “0”, the optical tilt amount is not compensated for but rather deteriorated since a feed back is applied with a target value corresponding to n-time offset value. Thus, it is important to accurately grasp the offset amount of each of the tilt sensor and the ACT for the optical disc tilt compensation apparatus which applies a tilt control to an objective lens. However, the above-mentioned patent document 5 does not disclose how to detect or compute the “0” point of the tilt amount.

Moreover, an optical pickup used for a combination drive, a super-combination drive or a multi-combination drive that corresponds to a plurality of wavelengths of light sources normally forms a spot diameter for three wavelengths by a single optical pickup (hereinafter, referred to as PU). That is, a part of the optical component parts arranged along an optical path of each wavelength is made common so as to attempt a cost reduction. For example, as shown in FIG. 5, the OL (objective lens) 2, the OLACT (objective lens actuator) 8 that drives the objective lens in a focusing direction (Fo) and tracking direction (Tr), and a ¼ wavelength plate 4 are made common, and first to third collimate lenses (CLs) 6a to 6c, first and second beam splitters (BSs) 3a and 3b, and first to third laser diodes (LDs) 1a to 1c are individually arranged to the optical paths. In such a case, since the common parts and separate parts are arranged so that each of the lights having different wavelengths forms an optimum spot diameter when assembling, the optical axes of the light beams do not match each other and an angle at which the optical disc tilt amount and the OL tilt amount are set to “0” varies for each wavelength.

### SUMMARY OF THE INVENTION

It is a general object of the present invention to provide an improved and useful tilt compensation apparatus and method in which the above-mentioned problems are eliminated.

A more specific object of the present invention is to provide a tilt compensation apparatus and method which minimizes a coma aberration generated due to a tilt of an optical disc by canceling a tilt offset amount of a tilt sensor.

In order to achieve the above-mentioned objects, there is provided according to one aspect of the present invention a tilt compensation apparatus comprising: an objective lens converging a light emitted by a light source mounted on an optical pickup and irradiating the light onto a recording surface of an optical recording medium; an objective lens tilt actuator controlling tilt of the objective lens; an objective lens tilt sensor detecting an amount of tilt of the objective lens; an optical recording medium tilt sensor detecting an amount of tilt of the optical recording medium; an operator computing an amount of relative tilt between the objective lens and the optical recording medium in accordance with the amount of tilt detected by the objective lens tilt sensor and the amount of tilt detected by the optical recording medium tilt sensor; a memory part storing an amount of offset of tilt generated in each of the objective lens tilt sensor and the optical recording medium tilt sensor; and an offset adjuster adjusting an amount of offset of tilt of the optical pickup in accordance with the amount of offset of tilt stored in the memory part.

In the tilt compensation apparatus according to the present invention, the memory part may store separately from each other the amount of offset of tilt generated by the objective lens tilt sensor, the amount of offset of tilt generated by the optical recording medium tilt sensor, and an amount of offset of the objective lens tilt actuator.

Additionally, in the tilt compensation apparatus according to the present invention, the optical recording medium may have a disc shape; the objective lens tilt actuator may be capable of performing a tilt control with respect to both a radial direction and a tangential direction of the optical recording medium having a disc shape; the objective lens tilt sensor and the optical recording medium tilt sensor may be capable of separately detecting an amount of tilt with respect to the radial direction and the tangential direction; and the memory part may stores separately the amounts of offset of tilt of each of the objective lens tilt sensor and the optical recording medium tilt sensor with respect to the radial direction and the tangential direction.

Additionally, the tilt compensation apparatus according to the present invention may further comprise a plurality of memory parts each of which stores an amount of offset of tilt of each of the objective lens tilt sensor and the optical recording medium tilt sensor for wavelengths of lights emitted by a plurality of light sources, the memory parts being provided separately on one memory part to one wavelength basis. A number of the wavelengths may be three, and a number of the plurality of memory parts may be three. The above-mentioned tilt compensation apparatus may further comprise a signal switch that selectively connects one of the plurality of memory parts to the offset adjuster.

Additionally, there is provided according to another aspect of the present invention a tilt compensation method comprising: initially adjusting an amount of tilt of an optical pickup so that a reference plane of the optical pickup is parallel to a reference optical recording medium that rotates within a plane perpendicular to a rotational axis of a spindle for rotating an optical recording medium; acquiring an amount of offset of tilt from a signal representing an amount of tilt detected in the optical pickup after the initial adjustment and storing the acquired amount of offset of tilt; and adjusting an amount of tilt of the optical pickup in accordance with the acquired amount of offset of tilt while the optical pickup is in operation.

The tilt compensation method according to the present invention may comprise: observing a beam spot formed by a light emitted by a light source provided in the optical pickup after the initial adjustment; controlling an amount of tilt of an objective lens according to a drive signal corresponding to a voltage or a current applied to an objective lens tilt actuator; storing, as an amount of offset of tilt, the drive signal that is applied to the objective lens tilt actuator when a coma aberration of the beam spot is minimized; and adjusting the control of tilt of the objective lens in accordance with a value acquired by subtracting the stored amount of offset of tilt from the drive signal supplied to the objective lens actuator while the control of tilt of the objective lens is performed.

The tilt compensation method according to the present invention may comprise: acquiring an amount of offset of tilt from an amount of tilt output from a tilt sensor mounted on the optical pickup after the initial adjustment, and storing the acquired amount of offset of tilt; and adjusting an amount of tilt of the optical pickup in accordance with a value acquired by subtracting the stored amount of offset of tilt from an amount of tilt output from the tilt sensor while the optical pickup is in operation.

Additionally, the tilt compensation method according to the present invention may comprise: acquiring an amount of offset of tilt from an amount of tilt output from an optical recording medium tilt sensor mounted on the optical pickup after the initial adjustment, and storing the acquired amount of offset of tilt; and adjusting an amount of tilt of the optical pickup in accordance with a value acquired by subtracting the stored amount of offset of tilt from an amount of tilt output from the optical recording medium tilt sensor while the optical pickup is in operation.

Further, the tilt compensation method according to the present invention may comprise: controlling an amount of tilt of an objective lens by applying a drive signal of a voltage or a current to an objective lens tilt actuator so as to minimize a coma aberration of a beam spot formed by a light emitted by a light source provided in the optical pickup after the initial adjustment; acquiring an amount of offset of tilt from an amount of tilt output from an optical recording medium tilt sensor when a coma aberration of the beam spot is minimized, and storing the acquired amount of offset of tilt; and adjusting an amount of tilt of the optical pickup in accordance with a value acquired by subtracting the stored amount of offset of tilt from an amount of tilt output from the optical recording medium tilt sensor while the optical pickup is in operation.

Additionally, there is provided according to another aspect of the present invention an optical recording and reproducing apparatus having one of the above-mentioned tilt compensation apparatuses, wherein recording or erasure of information on the optical recording medium is performed by irradiating and converging a light on a recording surface of the optical recording medium, and reproducing information is performed by detecting a light transmitted through or reflected by the optical recording medium by a light-receiving element.

According to the present invention, a tilt control error generated due to an error in an offset of each tilt signal can be remarkably reduced, which realizes the tilt compensation apparatus and method with an accurate tilt servo. Thereby, a high-quality beam spot having a minimum coma aberration can be formed on the recording surface of the optical recording medium, which realizes an optical pickup generating less reading error and providing a good writing quality and a recording and reproducing apparatus having such an optical pickup.

Other objects, features and advantages of the present invention will become more apparent from the following detailed description when read in conjunction with the accompanying drawings.

### BRIEF DESCRIPTION OF THE DRAWINGS

FIG. 1 is an illustration of a conventional mechanism including an objective lens and a four-axis actuator driving the objective lens in a normal state;

FIG. 2 is an illustration of the conventional mechanism shown in FIG. 1 in an abnormal state;

FIG. 3 is an illustration of the conventional mechanism shown in FIG. 1 in a compensated state;

FIG. 4 is an illustration of an outline of a conventional tilt compensation apparatus;

FIG. 5 is an illustration of a conventional optical pickup, which forms beam spot for three wavelengths;

FIG. 6 is an illustration of an outline structure of an optical disc tilt compensation apparatus according to a first embodiment of the present invention;

FIG. 7 is an illustration of an outline structure of an optical disc tilt compensation apparatus according to a second embodiment of the present invention;

FIG. 8 is an illustration of an outline structure of an optical disc tilt compensation apparatus according to a third embodiment of the present invention;

FIG. 9 is an illustration for explaining a concept of a tilt offset adjustment;

FIG. 10 is a flowchart of the tilt offset adjustment;

FIG. 11 is an illustration of the optical disc tilt compensation apparatus having a digital signal processor;

FIG. 12 is a block diagram of a digital signal processor shown in FIG. 11; and

FIG. 13 is an illustrative perspective view of an information recording and reproducing apparatus, which is an optical recording and reproducing apparatus according to a fourth embodiment of the present invention.

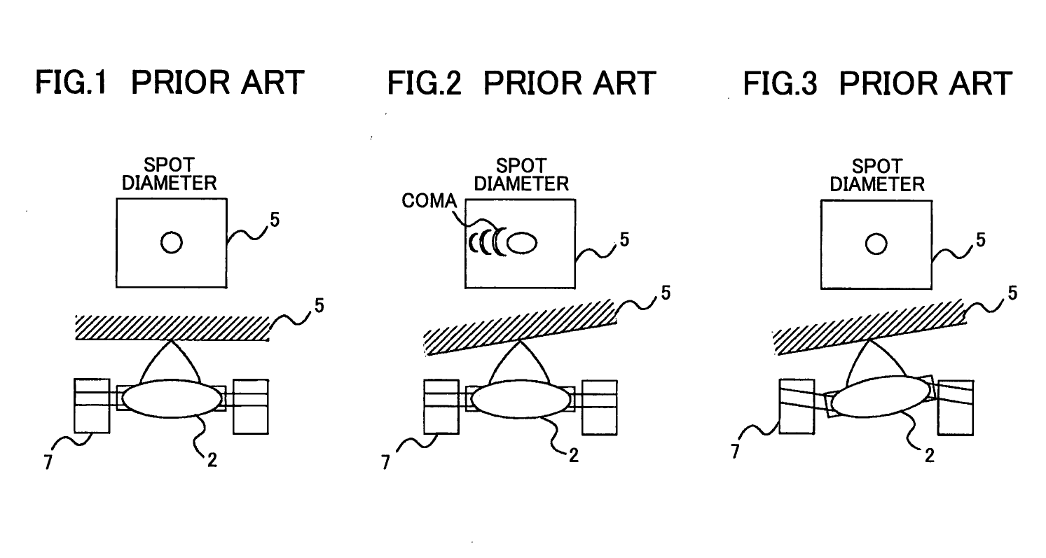

### DETAILED DESCRIPTION OF THE REFERRED EMBODIMENTS

A description will now be given of an optical disc tilt compensation apparatus according to a first embodiment of the present invention.

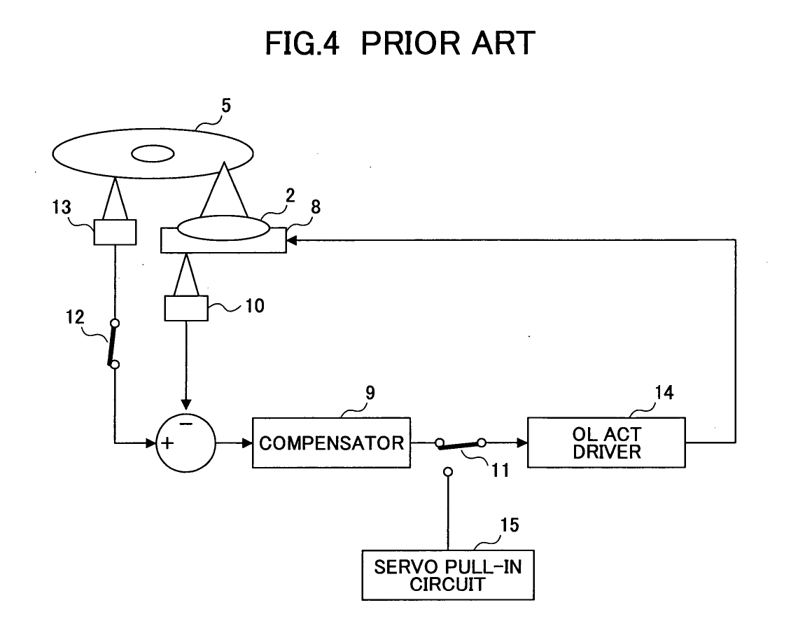

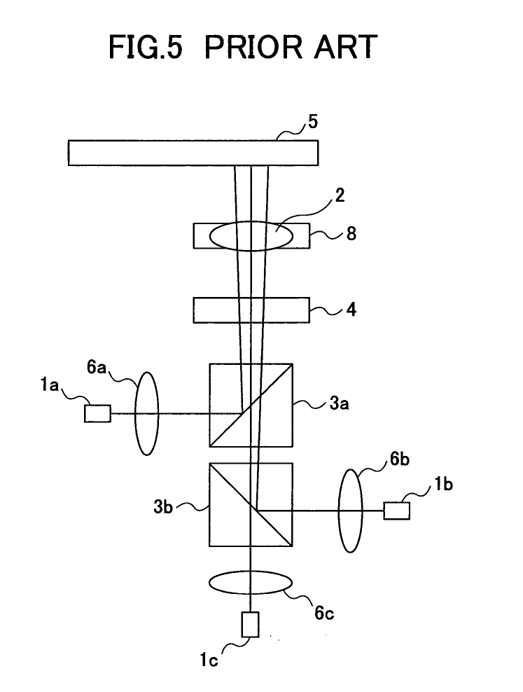

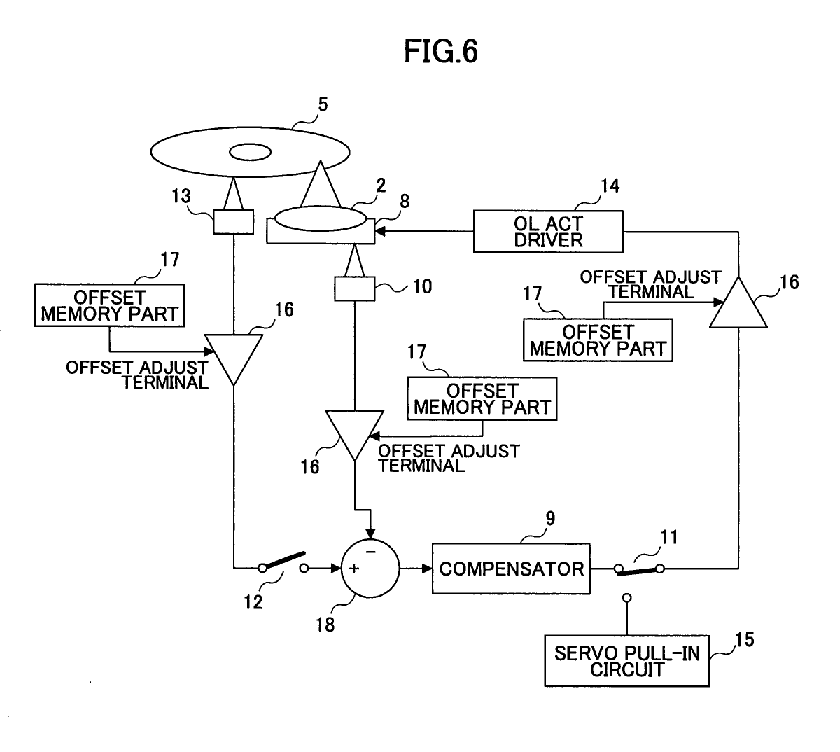

FIG. 6 is a block diagram of an optical disc tilt compensation apparatus according to the first embodiment of the present invention. In FIG. 6, parts that are the same as the parts shown in FIG. 4 are given the same reference numerals, and descriptions thereof will be omitted.

In the optical disc tilt compensation apparatus shown in FIG. 6, the OL tilt sensor 10 is located under the objective lens (OL) 2 so as to detect an amount of tilt (hereinafter, referred to as a tilt amount) of the OL 2. The OL tilt sensor 10 detects a tilt amount of the OL 2 and converts the tilt amount into an electric signal. Additionally, the optical disc tilt sensor 13 is located on a side of the optical disc 5 so as to detect a tilt amount of the optical disc 5.

Each of the tilt sensors is provided with an offset adjuster 16 for adjusting an offset, which adjusts an offset based on a previously acquired tilt offset amount. A difference between two offset-adjusted tilt amounts is acquired by an operator 18 and is supplied as a difference signal to the objective lens actuator (OLACT) driver 14 through a compensator 9. The OLACT driver 14 drives the objective lens actuator (OLACT) 8 in accordance with the difference signal of the tilt sensors. At that time, a tilt offset amount of the OLACT 8 is adjusted in accordance with an amount of offset of tilt (hereinafter, referred to as a tilt offset amount) previously stored in an offset memory part 17 in accordance with the OLACT 8 so that the OLACT 8 is driven by a drive voltage adjusted based on the adjusted tilt offset amount.

A description will be given of an example of acquiring the tilt offset amount previously stored in the offset memory part 17. First, a description will be given of the optical disc tilt sensor 13. A tilt reference optical disc is mounted to a spindle. The tilt reference optical disc has a flat surface having little tilt amount. A tilt of the tilt reference optical disc is measured by a tilt-measuring device such as an auto-collimator so as to set the measured tilt value to a reference value of “0”. The tilt amount output from the optical disc tilt sensor 13 in that state is stored as a tilt offset amount of the optical disc tilt sensor 13. A tilt offset amount of a radial direction and/or a tangential direction may also be stored separately. Additionally, an inclination of the optical disc tilt sensor 13 may be adjusted so that the tilt sensor output value becomes “0”. In such a case, the output value of the tilt sensor, which remains after adjustment, is stored as a tilt offset amount of the optical disc tilt sensor 13.

A description will be given of an example of acquiring the tilt offset amount of the OL tilt sensor 10. Similar to the adjustment of the optical disc tilt sensor 13, the tilt reference disc having a flat surface having little tile amount is mounted to the spindle, and the OLACT 8 is moved in a focusing direction so as to form a beam spot on the recording surface of the optical disc. Then, the spot configuration of the beam spot on the recording surface of the optical disc is measured using a measurement device such as a spot measuring device which can measure a converged beam spot. In this state, a tilt axis of the OLACT 8 is moved in a radial direction or a tangential direction so as to acquire an axis drive voltage or current by which a coma aberration generated by a tilt is minimized, and the electric physical amount such as a voltage value or a current value is recorded as a tilt offset amount of the OLACT 8.

Additionally, a tilt offset amount output from the OL tilt sensor 10 in the same state is stored as a tilt offset amount of the OL tilt sensor 10. The tilt offset amounts in the radial direction and the tangential direction may be stored separately. Additionally, the inclination of the OL tilt sensor 10 at that time may be adjusted so that the output value of the OL tilt sensor 10 becomes “0”. In such a case, an output value of the OL tilt sensor 10 remaining after the adjustment may be stored as a tilt offset amount of the OL tilt sensor 10. The offset adjustment of the OL tilt sensor 10 can be acquired by adjusting using a point at which the RF signal is maximum or a jitter is minimum such as signal quality evaluation.

A description will now be given of an operation of the optical disc tilt compensation apparatus according to the first embodiment of the present invention. In an initial state, the first switch (SW) 11 is connected to the servo pull-in circuit 15, and the second switch (SW) 12 is turned off. When the optical disc 5 is inserted into a drive (not shown) and is rotated by a spindle, a signal corresponding to an optical disc tilt amount is output from the optical disc tilt sensor 13. A tilt offset amount of the optical disc tilt sensor 13 previously acquired is stored in the offset memory part 17. Thus, the tilt offset amount in the optical disc tilt amount is cancelled by the offset adjuster 16, which subtracts the tilt offset amount stored in the offset memory part 17 from the optical disc tilt amount by the offset adjustor 16. Thus, the offset-adjusted signal corresponding to the optical disc tilt amount is a signal having the tilt offset amount set to “0”.

At the time of pull-in of a servo, the servo pull-in circuit 15 performs a servo pull-in, and the first SW 1 is connected to the compensator 9 to form a closed loop at a timing when the OL tilt amount becomes “0” so as to drive the OL tilt servo. Then, the second SW 12 is closed so that OL tilt amount is caused to follow the signal corresponding to the optical disc tilt amount output from the optical disc tilt sensor 13.

Additionally, the optical disc tilt compensation apparatus comprises a memory part other than offset memory parts for tilt sensors. The memory part serves as memory means for storing the tilt offset amount generated in each of the optical disc tilt sensor 13 and the OL tilt sensor 10. The memory part individually stores the tilt offset amount of the optical disc tilt sensor generated by the optical disc tilt sensor 13. The memory part also stores individually the tilt offset amount of the OLACT 8 separately from the offset memory parts of the tilt sensors. Therefore, the tilt offset amount individually generated in each block shown in FIG. 6 can be adjusted individually.

Further, the OLACT 8 is capable of performing a tilt control in two directions, the radial direction and the tangential direction, and the offset adjusters 16 are provided for the radial direction and the tangential direction, respectively. Moreover, the OL tilt sensor for detecting the tilt amount of the OL 2 and the optical disc tilt sensor for detecting the tilt amount of the optical disc 5 are tilt sensors that can detect tilt amounts in the radial direction and the tangential direction separately. Further, there is provided a memory part as memory means which separately stores the tilt offset amounts of each of the tilt sensors in the radial direction and tilt offset amounts in the tangential direction. The amount of the tilt offset amount of each of the tilt sensors and the tilt offset amount of the OLACT 8 in the radial direction and the tangential direction can be adjusted independently.

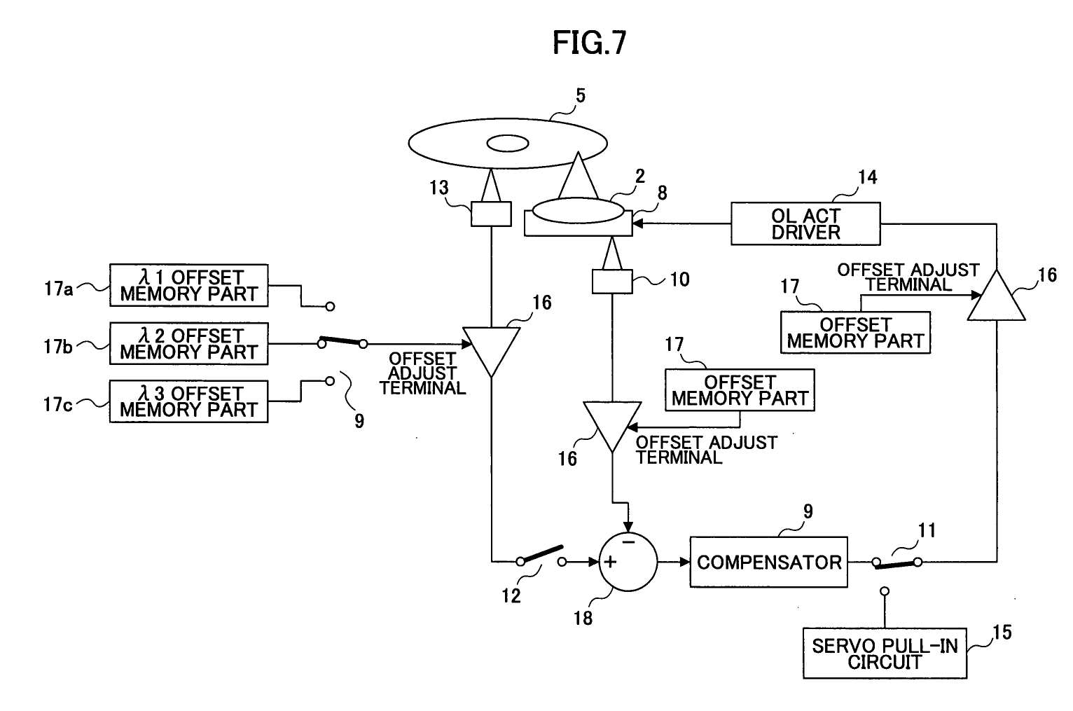

FIG. 7 is a block diagram of the optical disc tilt compensation apparatus according to a second embodiment of the present invention. In FIG. 7, parts that are tha same as the parts shown in FIG. 6 are given the same reference numerals, and descriptions thereof will be omitted. In the optical disc tilt compensation apparatus shown in FIG. 7, the objective lens (OL) tilt sensor 10 is located under the objective lens (OL) 2 to detect a tilt amount of the OL 2. The OL tilt sensor 10 detects a tilt amount of the OL 2 and converts the tilt amount into an electric signal. Additionally, the optical disc tilt sensor 13 is located on a side of the optical disc 5 so as to detect a tilt amount of the optical disc 5.

Each of the tilt sensors 10 and 13 is provided with an offset adjuster 16 for adjusting an offset, which adjusts an offset based on a previously acquired tilt offset amount. A difference between two offset-adjusted tilt amounts is acquired by the operator 18 and is supplied as a difference signal to the objective lens actuator (OLACT) driver 14 through the compensator 9. The OLACT driver 14 drives the objective lens actuator (OLACT) 8 in accordance with the difference signal of the tilt sensors. At that time, a tilt offset amount of the OLACT 8 is adjusted in accordance with a tilt offset amount previously stored in the offset memory part 17 in accordance with the OLACT 8 so that the OLACT 8 is driven by a drive voltage adjusted based on the adjusted tilt offset amount.

A description will be given of an operation of the optical disc tilt compensation apparatus according to the second embodiment of the present invention. In the initial state, the first switch (SW) 11 is connected to the servo pull-up circuit 15, and the second switch (SW) 12 is turned off. When the optical disc 5 is inserted into a drive (not shown) and is rotated by a spindle, a signal corresponding to an optical disc tilt amount is output from the optical disc tilt sensor 13. A tilt offset amount of the optical disc tilt sensor 13 previously acquired is stored in the offset memory part 17. Thus, the tilt offset amount in the optical disc tilt amount is cancelled by the offset adjuster 16, which subtracts the tilt offset amount stored in the offset memory part 17 from the optical disc tilt amount by the offset adjustor 16. The offset memory part 17 stores the tilt offset amounts corresponding to wavelengths separately so that an offset is adjusted by the offset adjuster 16 by selecting an optimum value from the plurality of tilt offset amounts stored in the offset memory part 17. The thus-adjusted signal corresponding to the optical disc tilt amount is a signal having the tilt offset amount set to “0”.

At the time of pull-in of a servo, the servo pull-in circuit 15 performs a servo pull-in, and the first SW 1 is connected to the compensator 9 at a timing when the OL tilt amount becomes “0” so as to drive the OL tilt servo. Then, the second SW 12 is closed so that OL tilt amount is caused to follow the signal corresponding to the optical disc tilt amount output from the optical disc tilt sensor 13. The offset adjustment of the OL tilt sensor 10 can be acquired by adjusting using a point at which the RF signal is maximum or a jitter is minimum such as signal quality evaluation.

Additionally, in the optical disc tilt compensation apparatus shown in FIG. 7, since the plurality of memory parts are provided so as to store the tilt offset amounts of the tilt sensors by each wavelength of the light source, an optimum tilt offset amount is selected and adjusted when the offset amount defers from wavelength to wavelength such as a case where an optical-axis of each wavelength is not perpendicular.

For example, it is assumed that there may be provided three light sources of different wavelengths as the plurality of wavelengths, a light source for CD (wavelength λ=785 nm), a light source for DVD (wavelength λ=660 nm) and a light source for BD (wavelength λ=405 nm), and three offset memory parts may also be provided so as to store tilt offset amounts of corresponding to three wavelengths, respectively. When the optical disc 5 is inserted into the drive and if it is determined that the inserted optical disc is a compact disc (CD), a tilt offset amount is adjusted according to an offset voltage for the CD light source by the offset adjuster 16. In FIG. 7, although three offset memory parts 17a, 17b and 17c corresponding to three wavelengths λ1, λ2 and λ3 are provided only to the optical disc tilt sensor 13, a plurality of offset memory parts for storing tilt offset amounts corresponding to a plurality of wavelengths may be provided to each of the OL tilt sensor 10 and the OLACT 8.

The optical disc tilt compensation apparatus shown in FIG. 7 is further provided with a signal switch 19 connected to the offset memory parts 17a, 17b and 17c. When supplying the tilt offset amounts corresponding to the different wavelengths form the offset memory parts 17a, 17b and 17c to the offset adjuster 16 through the offset adjust terminal, the signal switch 19 is operated to selectively connect one of the offset memory parts 17a, 17b and 17c to the offset adjuster 16.

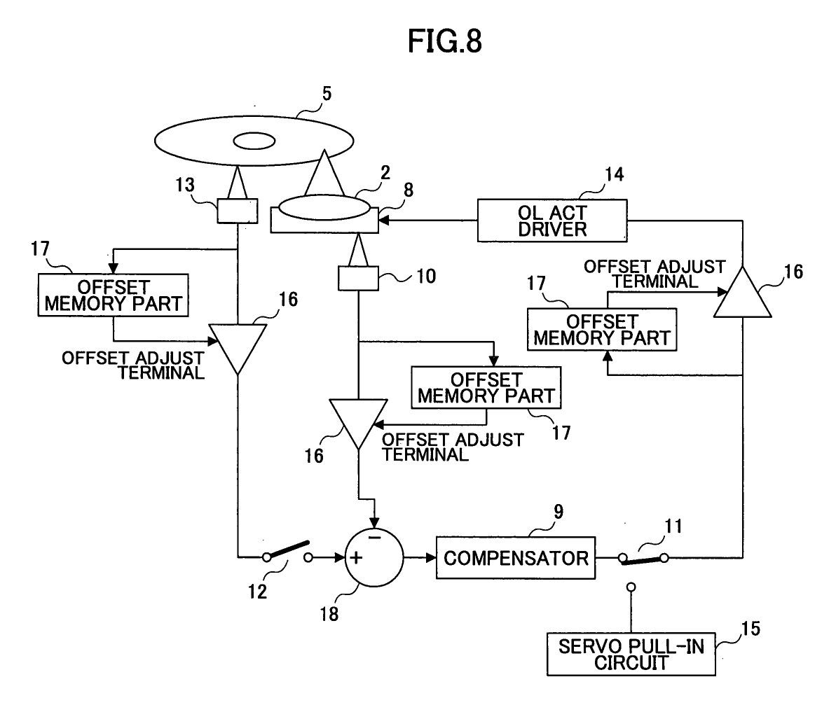

FIG. 8 is a block diagram of an optical disc tilt compensation apparatus according to a third embodiment of the present invention. In FIG. 8, parts that are the same as the parts shown in FIG. 6 are given the same reference numerals, and descriptions thereof will be omitted.

In the optical disc tilt compensation apparatus shown in FIG. 8, the OL tilt sensor 10 is located under the objective lens (OL) 2 so as to detect a tilt amount of the OL 2. The OL tilt sensor 10 detects a tilt amount of the OL 2 and converts the tilt amount into an electric signal. Additionally, the optical disc tilt sensor 13 is located on a side of the optical disc 5 so as to detect a tilt amount of the optical disc 5.

Each of the tilt sensors is provided with the offset adjuster 16 for adjusting an offset, which adjusts an offset based on a previously acquired tilt offset amount. A difference between two offset-adjusted tilt amounts is acquired by the operator 18 and is supplied as a difference signal to the objective lens actuator (OLACT) driver 14 through the compensator 9. The OLACT driver 14 drives the objective lens actuator (OLACT) 8 in accordance with the difference signal of the tilt sensors. At that time, the tilt offset amount of the OLACT 8 is adjusted in accordance with a tilt offset amount previously stored in the offset memory part 17 in accordance with the OLACT 8 so that the OLACT 8 is driven by a drive voltage adjusted based on the adjusted tilt offset amount.

A description will now be given of an operation of the optical disc tilt compensation apparatus according to the third embodiment of the present invention. In an initial state, the first switch (SW) 11 is connected to the servo pull-in circuit 15, and the second switch (SW) 12 is turned off. When the optical disc 5 is inserted into a drive (not shown) and is rotated by a spindle, a signal corresponding to an optical disc tilt amount is output from the optical disc tilt sensor 13. In an initial state, the first switch (SW) 11 is connected to the servo pull-in circuit 15, and the second switch (SW) 12 is turned off. When the optical disc 5 is inserted into a drive (not shown) and is rotated by a spindle, a signal corresponding to an optical disc tilt amount is output from the optical disc tilt sensor 13. A tilt offset amount of the optical disc tilt sensor 13 previously acquired is stored in the offset memory part 17. Thus, the tilt offset amount in the optical disc tilt amount is cancelled by the offset adjuster 16, which subtracts the tilt offset amount stored in the offset memory part 17 from the optical disc tilt amount by the offset adjustor 16. Thus, the offset-adjusted signal corresponding to the optical disc tilt amount is a signal having the tilt offset amount set to “0”.

At the time of pull-in of a servo, the servo pull-in circuit 15 performs a servo pull-in operation, and the first SW 1 is connected to the compensator 9 to form a closed loop at a timing when the OL tilt amount becomes “0” so as to drive the OL tilt servo. Then, the second SW 12 is closed so that OL tilt amount is caused to follow the signal corresponding to the optical disc tilt amount output from the optical disc tilt sensor 13. The offset adjustment of the OL tilt sensor 10 can be acquired by adjusting using a point at which the RF signal is maximum or a jitter is minimum such as signal quality evaluation.

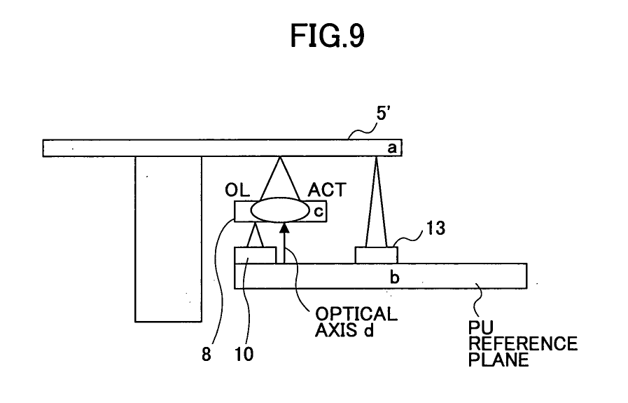

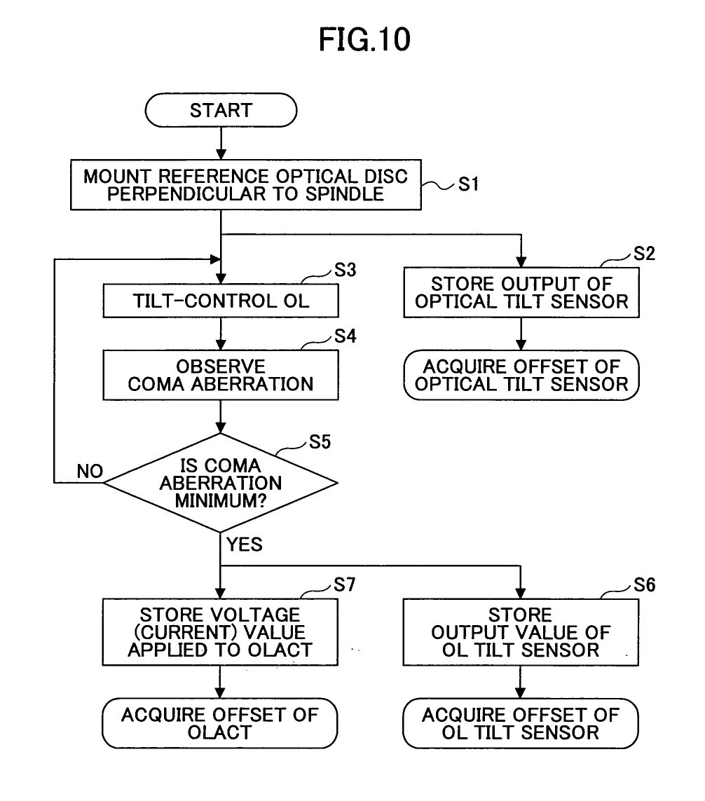

A description will now be given of an adjusting method of the tilt offset of the optical disc tilt sensor. FIG. 9 is an illustration for explaining a concept of the tilt offset adjustment. FIG. 10 is a flowchart of the tilt offset adjustment. First, assembly and adjustment of optical axis of the optical pickup (PU) with respect to each wavelength are carried out using a PU reference plane “b” as a reference. Accordingly, an angle of an optical axis “d” with respect to the PU reference plane “b” shown in FIG. 9 has a minimum dispersion among the wavelengths.

In the tilt offset adjustment shown in FIG. 10, a reference optical disc 5′, which has no tilt amount, is mounted to a spindle first. Then, the PU reference plane “b” is adjusted using an auto-collimator while rotating the spindle so that a surface “a” of the reference optical disc 5′ and the PU reference plane “b” are parallel to each other (step S1). After completion of the adjustment, an output value of the optical disc tilt sensor 13 is detected, and the detected value is stored in the offset memory part 17 as a tilt offset amount of the optical disc tilt sensor 13 (step S2). Using the thus-stored tilt offset amount of the reference optical disc 5′, the offset adjustment is carried out to acquire the true optical disc tilt amount by subtracting the tilt offset amount stored in the offset memory part 17 from the output value of the optical disc tilt sensor 13 during operation, that is, when detecting a tilt of an optical disc.

Additionally, a description will be given of the adjusting method of the tilt offset of the OLACT 8. After the adjustment of the tilt offset of the optical disc tilt sensor 13, a tilt control is performed at each wavelength by driving the PU and applying a focus servo (step S3). Then, a beam spot formed on a surface of the reference optical disc by a light beam emitted from the optical pickup is observed (step S4). Thereafter, a tilt axis of the OLACT 8 is driven (step S5), and stop the tilt control of the OLACT 8 at a position where a coma aberration is minimized (Yes of step S5). Then, a value of a drive voltage or a drive current applied to the OLACT 8 is stored in the offset memory part 17 as a tilt offset amount of the OLACT 8 (step S6). During an operation, that is, when performing the tilt control of the objective lens (OL), the offset adjustment is carried out by setting a drive signal of the tilt control of the OLACT 8 to a value acquired by subtracting the tilt offset amount stored in the offset memory part 17 from the OLACT drive signal.

Further, a description will be given of the adjusting method of the tilt offset of the OL tilt sensor 10. After the adjustment of the tilt offset of the optical disc tilt sensor 13, applying a focus servo if applied by driving the pickup (step S3). Then, a beam spot formed on a surface of the reference optical disc by a light beam emitted from the optical pickup is observed (step S4). Thereafter, a tilt axis of the OLACT 8 is driven (step S5), and stop the tilt control of the OLACT 8 at a position where a coma aberration is minimized (Yes of step S5). Then, an output value of the OL tilt sensor 10 is detected, and the detected value is stored in the offset memory part 17 as the tilt offset amount of the OL tilt sensor 10 (step S7). During an operation, that is, when performing the detection of the OL tilt amount, the offset adjustment is carried out by setting the OL tilt amount to a value acquired by subtracting the tilt offset amount stored in the offset memory part 17 from the output value of the OL tilt sensor 10.

As mentioned above, the tilt offset amounts generated in the tilt sensors acquired by the tilt adjustments are stored in the offset memory parts 17 shown in FIG. 8 so that a beam spot having less coma aberration can be formed by carrying out the tilt adjustment using the stored tilt offset amount when driving the pickup.

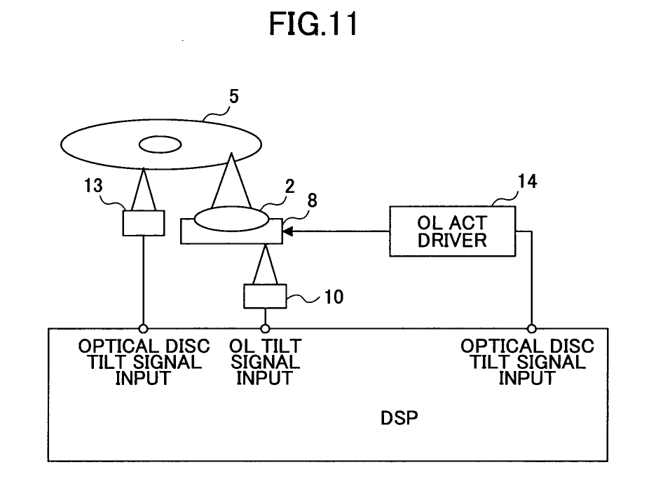

FIG. 11 is an illustration of the optical disc tilt compensation apparatus according to one of the above-mentioned embodiments and having a digital signal processor to realize the operation. Each block associated with the control operation in the optical disc tilt compensation apparatus can be realized by analog circuits or digital circuits, and a large part of the optical disc tilt compensation apparatus can be constructed by a digital signal processor (DSP). The above-mentioned operation of the apparatus can be realized according to a program of the DSP. The detection signal of each tilt sensor is input to the DSP, and the DSP adjusts the tilt offset amount of each of the OL tilt sensor 10 and the optical disc tilt sensor 13 and the OLACT 8, and produces a drive signal of the OLACT 8.

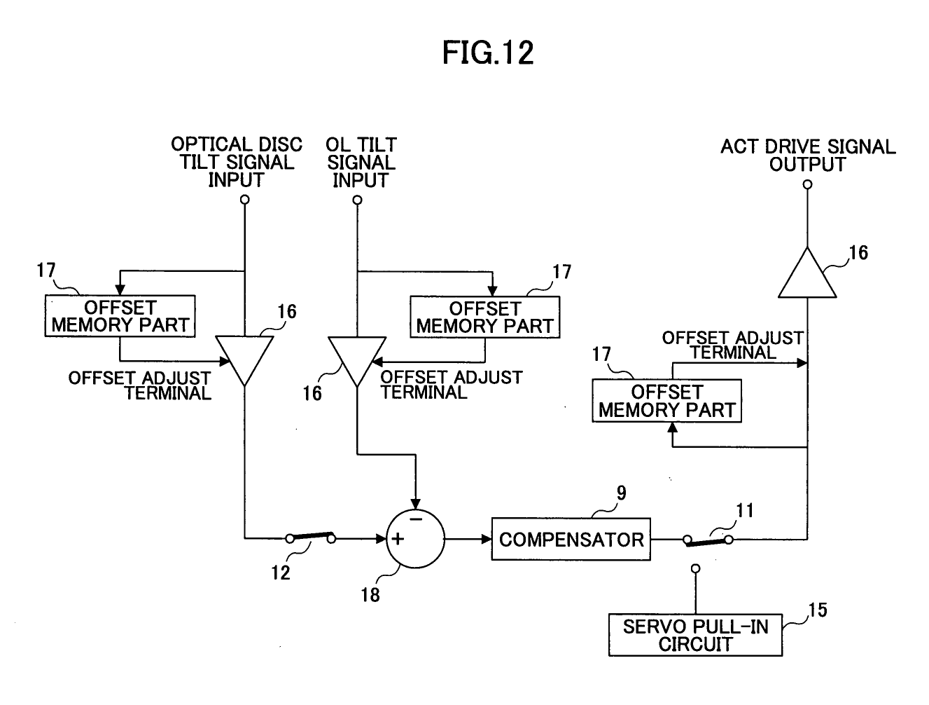

FIG. 12 is a block diagram of the DSP provided in the optical disc tilt compensation apparatus shown in FIG. 11. As shown in this FIG. 12, the structure shown in FIG. 6 can be constructed according to software.

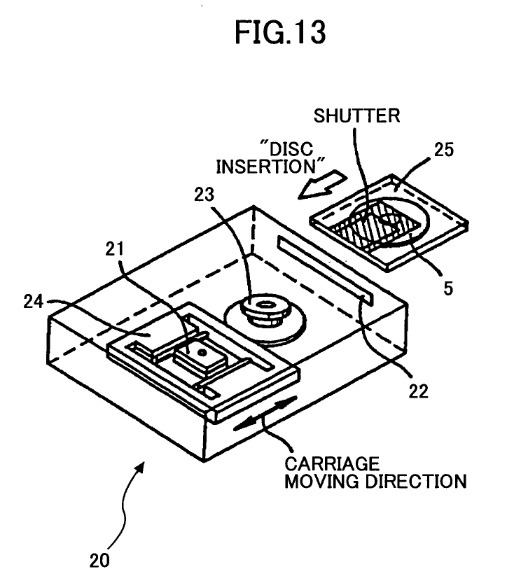

FIG. 13 is a perspective view of an information recording and reproducing apparatus which is an optical recording and reproducing apparatus according to a fourth embodiment of the present invention. As shown in FIG. 13, the information recording and reproducing apparatus 20 performs at least one of information recording, reproduction and erasure using an optical pickup 21 with respect to an optical disc 5. In the fourth embodiment of the present invention, the optical disc 5 is accommodated in a cartridge 25 of a protective case. The optical disc 5 is inserted and set into the information recording and reproducing apparatus 20 in a disc insertion direction indicated by an arrow accompanied by “DISC INSERTION”, and is rotated by a spindle motor 23 so that information recording, reproduction or erasure is performed while the optical disc 5 is being rotated. It should be noted that the optical disc 5 is not necessarily accommodated in the cartridge 25, and may be in an uncovered state.

The information recording and reproducing apparatus according to the fourth embodiment of the present invention comprises the tilt compensation apparatus according to one of the above-mentioned first through third embodiments, and performs information recording or erasure by irradiating a light emitted by a light source to converge on a recording surface of the optical disc 5 and also performs information reproduction by detecting a transmitted light or a reflected light from the optical disc 5 or converged light converged by a signal detection optical system by a light-receiving element. By being equipped with the above-mentioned tilt compensating apparatus, a coma aberration is reduced to the maximum and a high-quality beam spot can be formed on a surface of an optical disc. Thus, an optical pickup having less reading error and a good writing quality can be achieved, and also an information recording and reproducing apparatus having such an optical pickup can be achieved.

The present invention is not limited to the specifically disclosed embodiments, and variations and modifications may be made without departing from the scope of the present invention.

The present application is based on the Japanese priority application No. 2004-046266 filed Feb. 23, 2004, the entire contents of which are hereby incorporated herein by reference.

1. A tilt compensation apparatus comprising:
an objective lens converging a light emitted by a light source mounted on an optical pickup and irradiating the light onto a recording surface of an optical recording medium;
an objective lens tilt actuator controlling tilt of said objective lens;
an objective lens tilt sensor detecting an amount of tilt of said objective lens;
an optical recording medium tilt sensor detecting an amount of tilt of said optical recording medium;
an operator computing an amount of relative tilt between said objective lens and said optical recording medium in accordance with the amount of tilt detected by said objective lens tilt sensor and the amount of tilt detected by said optical recording medium tilt sensor;
a memory part storing an amount of offset of tilt generated in each of said objective lens tilt sensor and said optical recording medium tilt sensor; and
an offset adjuster adjusting an amount of offset of tilt of said optical pickup in accordance with the amount of offset of tilt stored in said memory part.

2. The tilt compensation apparatus as claimed in claim 1, wherein said memory part stores separately from each other the amount of offset of tilt generated by said objective lens tilt sensor, the amount of offset of tilt generated by said optical recording medium tilt sensor, and an amount of offset of said objective lens tilt actuator.

3. The tilt compensation apparatus as claimed in claim 1, wherein said optical recording medium has a disc shape;
said objective lens tilt actuator is capable of performing a tilt control with respect to both a radial direction and a tangential direction of said optical recording medium having a disc shape;
said objective lens tilt sensor and said optical recording medium tilt sensor are capable of separately detecting an amount of tilt with respect to the radial direction and the tangential direction; and
said memory part stores separately the amounts of offset of tilt of each of said objective lens tilt sensor and said optical recording medium tilt sensor with respect to the radial direction and the tangential direction.

4. The tilt compensation apparatus as claimed in claim 1, further comprising a plurality of memory parts each of which stores an amount of offset of tilt of each of said objective lens tilt sensor and said optical recording medium tilt sensor for wavelengths of lights emitted by a plurality of light sources, the memory parts being provided separately on one memory part to one wavelength basis.

5. The tilt compensation apparatus as claimed in claim 4, wherein a number of the wavelengths is three, and a number of said plurality of memory parts is three.

6. The tilt compensation apparatus as claimed in claim 4, further comprising a signal switch that selectively connects one of said plurality of memory parts to said offset adjuster.

7. A tilt compensation method comprising:
initially adjusting an amount of tilt of an optical pickup so that a reference plane of the optical pickup is parallel to a reference optical recording medium that rotates within a plane perpendicular to a rotational axis of a spindle for rotating an optical recording medium;
acquiring an amount of offset of tilt from a signal representing an amount of tilt detected in said optical pickup after the initial adjustment and storing the acquired amount of offset of tilt; and
adjusting an amount of tilt of said optical pickup in accordance with the acquired amount of offset of tilt while said optical pickup is in operation.

8. The tilt compensation method as claimed in claim 7, comprising:
observing a beam spot formed by a light emitted by a light source provided in said optical pickup after the initial adjustment;
controlling an amount of tilt of an objective lens according to a drive signal corresponding to a voltage or a current applied to an objective lens tilt actuator;
storing, as an amount of offset of tilt, the drive signal that is applied to said objective lens tilt actuator when a coma aberration of said beam spot is minimized; and
adjusting the control of tilt of the objective lens in accordance with a value acquired by subtracting the stored amount of offset of tilt from the drive signal supplied to said objective lens actuator while the control of tilt of the objective lens is performed.

9. The tilt compensation method as claimed in claim 7, comprising:
acquiring an amount of offset of tilt from an amount of tilt output from a tilt sensor mounted on said optical pickup after the initial adjustment, and storing the acquired amount of offset of tilt; and
adjusting an amount of tilt of said optical pickup in accordance with a value acquired by subtracting the stored amount of offset of tilt from an amount of tilt output from said tilt sensor while said optical pickup is in operation.

10. The tilt compensation method as claimed in claim 7, comprising:
acquiring an amount of offset of tilt from an amount of tilt output from an optical recording medium tilt sensor mounted on said optical pickup after the initial adjustment, and storing the acquired amount of offset of tilt; and
adjusting an amount of tilt of said optical pickup in accordance with a value acquired by subtracting the stored amount of offset of tilt from an amount of tilt output from said optical recording medium tilt sensor while said optical pickup is in operation.

11. The tilt compensation method as claimed in claim 9, comprising:
controlling an amount of tilt of an objective lens by applying a drive signal of a voltage or a current to an objective lens tilt actuator so as to minimize a coma aberration of a beam spot formed by a light emitted by a light source provided in said optical pickup after the initial adjustment;
acquiring an amount of offset of tilt from an amount of tilt output from an optical recording medium tilt sensor when a coma aberration of said beam spot is minimized, and storing the acquired amount of offset of tilt; and
adjusting an amount of tilt of said optical pickup in accordance with a value acquired by subtracting the stored amount of offset of tilt from an amount of tilt output from said optical recording medium tilt sensor while said optical pickup is in operation.

12. An optical recording and reproducing apparatus having an optical recording medium tilt compensation apparatus, wherein said optical recording medium tilt compensation apparatus comprising:
an objective lens converging a light emitted by a light source mounted on an optical pickup and irradiating the light onto a recording surface of an optical recording medium;
an objective lens tilt actuator controlling tilt of said objective lens;
an objective lens tilt sensor detecting an amount of tilt of said objective lens;
an optical recording medium tilt sensor detecting an amount of tilt of said optical recording medium;
an operator computing an amount of relative tilt between said objective lens and said optical recording medium in accordance with the amount of tilt detected by said objective lens tilt sensor and the amount of tilt detected by said optical recording medium tilt sensor;
a memory part storing an amount of offset of tilt generated in each of said objective lens tilt sensor and said optical recording medium tilt sensor; and
an offset adjuster adjusting an amount of offset of tilt of said optical pickup in accordance with the amount of offset of tilt stored in said memory part,
wherein recording or erasure of information on the optical recording medium is performed by irradiating and converging a light on a recording surface of the optical recording medium, and reproducing information is performed by detecting a light transmitted through or reflected by the optical recording medium by a light-receiving element.

13. The optical recording and reproducing apparatus as claimed in claim 12, wherein the light to be received by said light-receiving element is converged by a signal detection optical system.

14. The optical recording and reproducing apparatus as claimed in claim 12, wherein said memory part stores separately from each other the amount of offset of tilt generated by said objective lens tilt sensor, the amount of offset of tilt generated by said optical recording medium tilt sensor, and an amount of offset of said objective lens tilt actuator.

15. The optical recording and reproducing apparatus as claimed in claim 12, wherein said optical recording medium has a disc shape;
said objective lens tilt actuator is capable of performing a tilt control with respect to both a radial direction and a tangential direction of said optical recording medium having a disc shape;
said objective lens tilt sensor and said optical recording medium tilt sensor are capable of separately detecting an amount of tilt with respect to the radial direction and the tangential direction; and
said memory part stores separately the amounts of offset of tilt of each of said objective lens tilt sensor and said optical recording medium tilt sensor with respect to the radial direction and the tangential direction.

16. The optical recording and reproducing apparatus as claimed in claim 12, further comprising a plurality of memory parts each of which stores an amount of offset of tilt of each of said objective lens tilt sensor and said optical recording medium tilt sensor for wavelengths of lights emitted by a plurality of light sources, the memory parts being provided separately on one memory part to one wavelength basis.

17. The optical recording and reproducing apparatus as claimed in claim 16, wherein a number of the wavelengths is three, and a number of said plurality of memory parts is three.

18. The optical recording and reproducing apparatus as claimed in claim 16, further comprising a signal switch that selectively connects one of said plurality of memory parts to said offset−adjuster.
